(19) United States
(12) Patent Application Publication
(10) Pub. No.: US 2015/0007014 A1
(43) Pub. Date: Jan. 1, 2015

(54) Detect and Automatically Hide Spoiler Information in a Collaborative Environment

(71) Applicant: International Business Machines Corporation, Armonk, NY (US)

(72) Inventor: Corville O. Allen, Morrisville, NC (US)

(21) Appl. No.: 14/488,820

(22) Filed: Sep. 17, 2014

Related U.S. Application Data
(63) Continuation of application No. 13/850,347, filed on Mar. 26, 2013.

(51) Int. Cl. G06F 17/27; G06F 3/0484; G06F 17/24

(52) U.S. Cl. CPC G06F 17/2775; G06F 17/241; G06F 3/04842
USPC 715/231

(57) ABSTRACT

An approach is provided to detect and hide spoiler information. In the approach, potential spoiler content included user text entries submitted to a collaborative environment are automatically detected. The system inhibits display of the potential spoiler content from the collaborative environment in response to the detection.

### TECHNICAL FIELD

The present disclosure relates to an approach that automatically detects and hides potential spoiler information found in posts made to a collaborative environment.

### BACKGROUND OF THE INVENTION

When users participate in a forum by posting messages and comments against a specified topic, they can sometimes accidentally put information in their post that contains spoiler information that gives away clues, goals and outcomes of an event, book, television show, or game. This creates a problem for people who actually do not want such information before they have experienced the content themselves, but still want to discuss previous episodes or content with like-minded individuals. Prematurely viewing such content can ruin a movie ending, book ending or dramatic event for a viewer.

### SUMMARY

An approach is provided to detect and hide spoiler information. In the approach, potential spoiler content included user text entries submitted to a collaborative environment are automatically detected. The system inhibits display of the potential spoiler content from the collaborative environment in response to the detection.

In one embodiment, the inhibiting of the entry is performed until an evaluation of the potential spoiler content is performed. In this embodiment, the potential spoiler content is evaluated by comparing the potential spoiler content to content filter data, such as content provider set of content filter data and a user configurable set of content filter data. A spoiler tag is inserted in response to the comparison identifying that the potential spoiler content is spoiler content. The spoiler tag is a tag, such as a command button or hypertext, that is selectable by users of the collaborative environment to reveal the spoiler content. The potential spoiler content is displayed in response to the comparison revealing that it is not spoiler content. The automatic detecting and comparing are performed according to a semantic analysis of the received user text entry.

In a further embodiment, a spoiler tag selection is received from one of the collaborative environment users corresponding to a spoiler tag. The spoiler content is displayed to the selected user in response to receiving the spoiler tag selection.

In one embodiment, the spoiler content is periodically re-evaluated to ascertain whether the content is still spoiler content. During re-evaluation, the spoiler content is compared to a set of event data, such as updated set of content provider set of content filter data, an updated set of user configurable set of content filter data, a presentation of an episode, a user progress in an electronic game, a product announcement, and an arrival of a calendar date. The spoiler tag is retained in response to the comparison identifying that the spoiler content is still spoiler content, however the spoiler content is displayed without the spoiler tag in response to the comparison identifying the that the spoiler content is no longer spoiler content.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in detecting and hiding spoiler information in a collaborative setting;

FIG. 4 is a depiction of a flowchart showing the logic used in spoiler alert user setup processing;

FIG. 5 is a depiction of a flowchart showing the logic used in spoiler alert setup by the content provider;

FIG. 6 is a depiction of a flowchart showing the logic used by a spoiler identification engine;

FIG. 7 is a depiction of a flowchart showing the logic performed to handle a user's individual custom spoiler settings;

FIG. 8 is a depiction of a flowchart showing the logic used to display collaborative content on a user's display device; and

FIG. 9 is a depiction of a flowchart showing the logic used to display posts on the user's display device.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

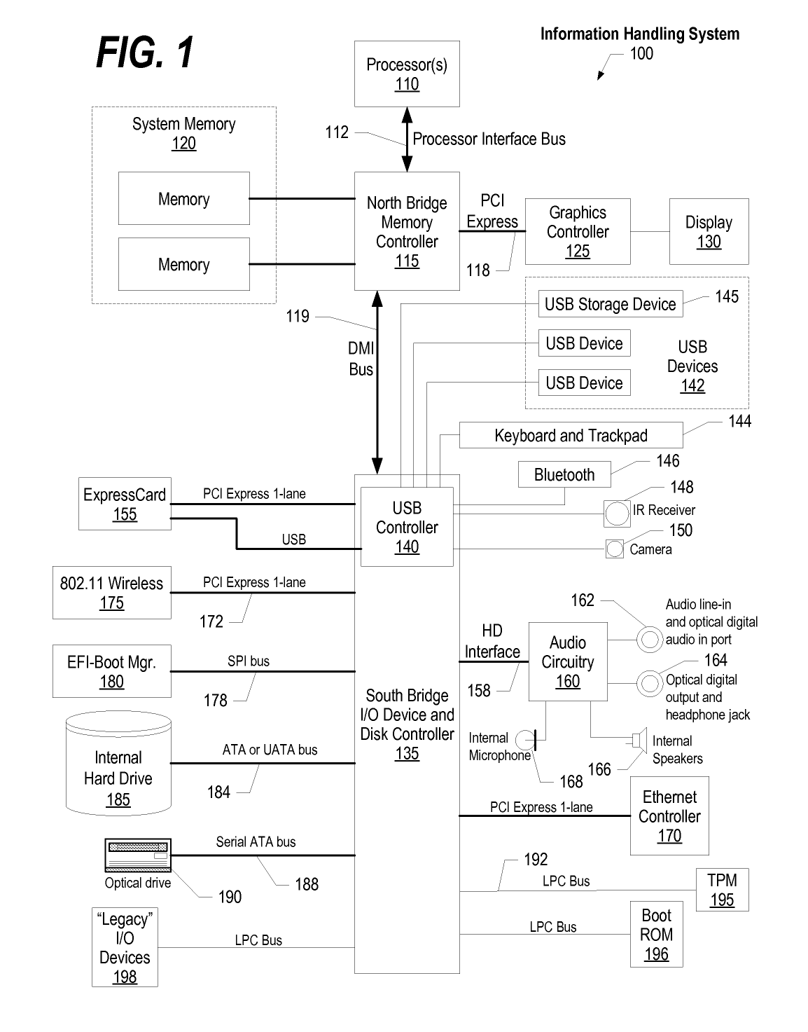

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

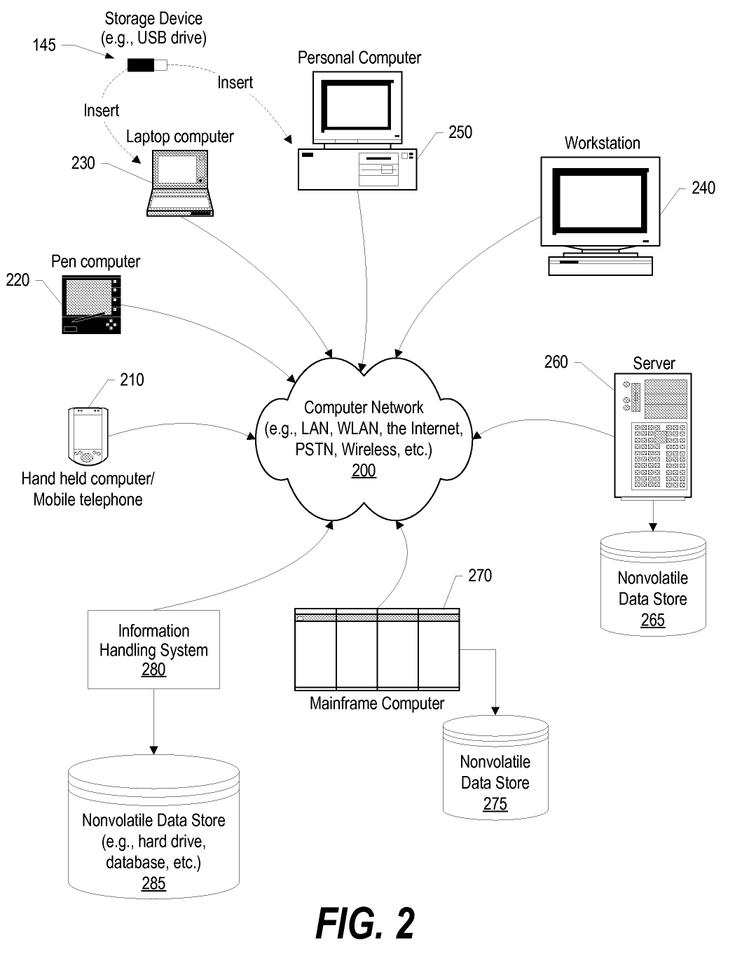

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

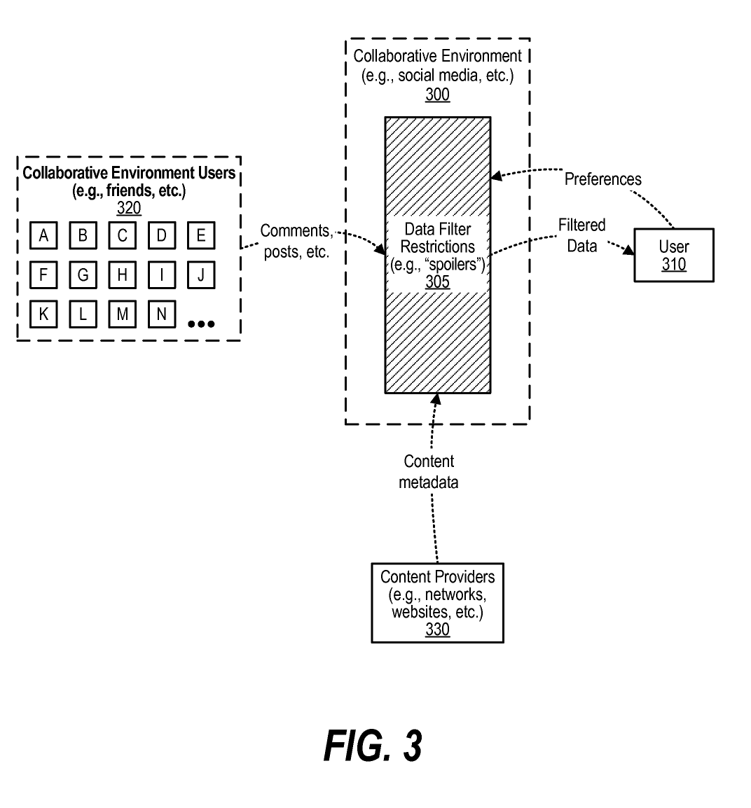

FIGS. 3-9 depict an approach that can be executed on an information handling system, such as a mobile device, and computer network as shown in FIGS. 1-2. The core idea of this invention is to detect when a user is about to post comments or posts to a forum topic and the content contains information that give future facts or speculation around main events in the context of the topic. When this detection occurs, the approach presented herein changes the user's post to include forum specific mark-up elements that hide and tag the content as spoiler data. In this manner, the spoiler data is not clearly visible to everyone on the forum when the content gets posted. This solution automatically checks the content and thereby prevents spoiler data from being accidentally viewed. This approach is also applied to live feeds, such as contemporaneous comments about a television episode where people are watching together and commenting while the program is playing. The approach can be used in game forums, book forums, and the like.

In one embodiment, when a user creates a forum topic, the user categorizes it, denote the context of the forum, and then identify the main content that the topic should govern. This includes establishing restrictions such as episodes that are free to be posted or a complete game or book chapter, or the entire book. For example: “<Program Name> TV Episode 7 Free episodes up to 7 Restrictions episodes after 7.” A simple form is provided for content that is not readily available, where the user can provide key events in natural language text based on main characters and events that happen to them, or provide a summary of their own for events that occurred before. Further, the information from previous posts in the previous chapters will be collected and categorized. For TV Episodes the summary of the episodes will be used to highlight events throughout the show. Once this corpora of information is collected and events around main characters are identified, they will be used to detect spoilers. When a user makes a post, the language is parsed and analyzed to identify main characters, actions taken by main characters and whether they are speculative or fact based and whether those facts have occurred in previous sections or episodes. If the post is fact based and has not been part of the topic corpus of facts, then the post will be automatically tagged as spoiler. Speculative posts can be keyed on phrases such as, “I wonder”, “I wish”, “What do you think if”, that express opinions that are foretelling possible actions by main or important characters. Once the spoiler detection automatically takes place on the server, the spoiler tags are inserted in the post before the post is viewable by the online community. Spoiler tags can be command buttons, hyperlinks, or any visual indicator that informs the user of the hidden spoiler content and allows the user to read the spoiler content if so desired, e.g., by selecting a graphic user interface (GUI) associated with the spoiler tag, etc. This results in the spoiler tags being inserted to hide the content.

Regarding games, such as on-line or multi-player games, such games are typically linear with some element changes of characters. In a gaming embodiment, the system is trained to gather facts about the game and when such events occur (e.g., Act 1, Part 1, or Level 6, etc.) and the system retrieves the facts based on such information. Additionally, game guides can be used to build the corpus for a particular game. The system then ties posts against facts of the game. For example: “<game title> Chapter 3 topic discussion Free discussion: Chapters up to 3 (1, 2, 3) Restrictions: Chapters 4 to end.” Regarding the corpus of facts categorized, the categorized facts includes facts regarding aspects such as: Fact, Location in Media, Location in Context, Related Main Characters, and Affected Characters. For example: <game title>—Act 2-Fact: Drake (main character) finds the key to the Monastery—Location in Media: Level 3, Act 2, 44 minutes play time—Location in Context: Level 3, Act 2—Related Main Characters: Anna, Jacob—Affected Characters: Marco.” The Fact above is identified by analyzing the game guide and information about the game that is ingested. The Location is noted by guide and sections as described by game detailed data ingested. The relation to Anna is kept as information that was given about the subject (key) and the characters that have been interested in the subject throughout previous chapters parts of the media. Affected are direct characters that have the same or similar goal. Oftentimes, games provide goals or quests that are embedded in the game as achievements that are clearly given to users. Consequently, this data is readily found and ingested by the system. Furthermore, facts are built by analyzing posts from previous sections that build upon the original corpus that state facts that have happened in a particular contextual location (e.g., “Act 1,” etc.) where the system builds more user based fact formats that are used to detect matches for future posts. In one embodiment, the text is stored in both raw fact form and annotated, and categorized in their noun, verb subject formats. This embodiment can be extended to live feeds, such as contemporaneous comments (posts) regarding a television episode. Further details and examples depicting various embodiments of the approach that automatically detects and hides spoiler information are shown in FIGS. 3-9, descriptions of which are found below.

FIG. 3 is a component diagram showing the various components used in detecting and hiding spoiler information in a collaborative setting. Collaborative environment 300, such as a social media website, contemporaneous posting website, etc. includes data filter restrictions 305 that identify potential spoiler content. User text entries, such as comments, posts, tweets, etc. are submitted by collaborative environment users 320, such as social media “friends,” “colleagues,” “followers,” and the like. Other examples of collaborative environments in addition to social media sites and contemporaneous posting sites include on-line virtual workplaces where employees, students and teachers, friends, colleagues, and the like can communicate, share information and work together. Collaborative environments can be specifically focused, such as to a particular interest, organization, group, etc. or can have a general focus of interest to users with a wide variety of interests, backgrounds, educations, and the like.

Various sets of content filter data can included in data filter restrictions 305. For example, content filter data can be a content provider set of content filter data, provided by content providers 330. Additionally, content filter data can be user configurable data, such as preferences, configured by user 310 of the collaborative environment. When potential spoiler content is identified by a process running at collaborative environment 300, the process inhibits display of the potential spoiler content to users of the environment, such as user 310. In one embodiment, the collaborative environment identifies spoiler content according to a semantic analysis that is performed on the received user text entry. During the semantic analysis, the user text entry is parsed and natural language processing is used to extract context-independent aspects of the user text entry's meaning, including the semantic roles of entities mentioned in the user text entry, such as character names found in television episodes, games, sporting events, etc., as well as quantification information, such as cardinality, iteration, and dependency information included in the user text entry.

In one embodiment, further evaluation of the potential spoiler content is performed by comparing the potential spoiler content to various sets of content filter data. For example, content provider 330 may provide content filter data that provides details about television episodes in a particular series and indicates which episodes are older episodes that are not restricted by the content filter data and which episodes are restricted by the content filter data. If a post made by a user of environment 320 matches one of the non-restricted episodes, such as an older episode, then the post is displayed to other users of the collaborative environment. However, if the post made by the user matches one of the restricted episodes, such as the currently playing episode, then the post is inhibited from display to the other users of the collaborative environment. In this case, a “spoiler tag” is inserted in the post indicating that the post includes spoiler content that may spoil the viewing of the episode by a user that has not yet had the opportunity to watch the episode. A user of the collaborative environment can select the spoiler tag, such as small command button or hyperlink included in the post, in order to view the spoiler content. For example, if user 310 has already viewed the most recent episode to which the post and spoiler content relates to, then the user may wish to select the spoiler tag in order to view the spoiler contents, such as another user's commentary on the most recent episode.

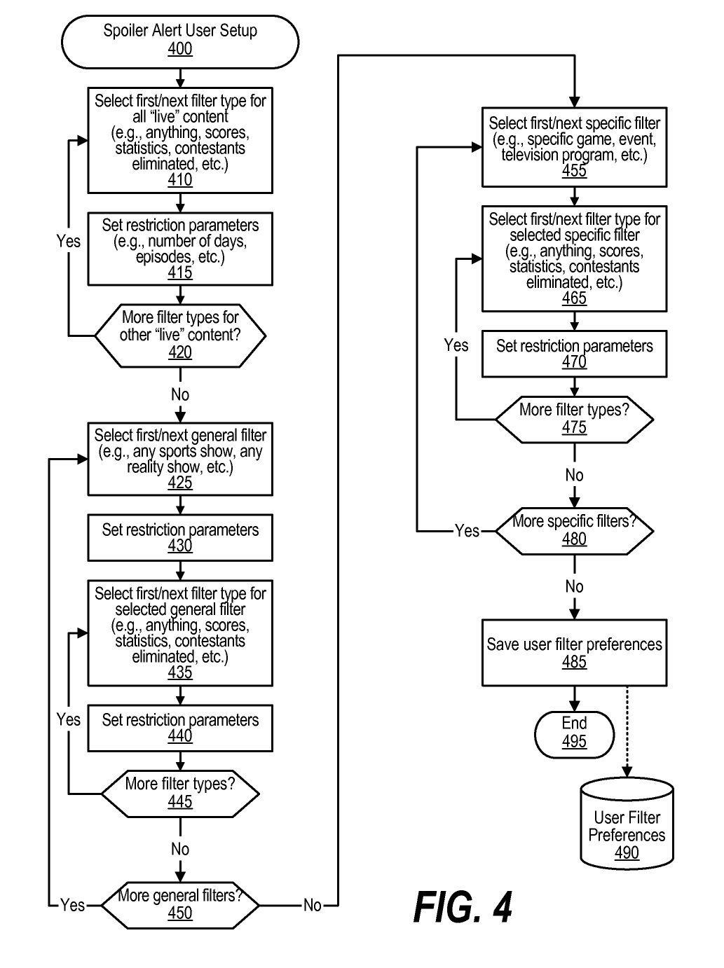

In one embodiment, the user can provide another set of content filter data, such as a set of preferences, that is used to identify spoiler content. This embodiment may be used separately or in conjunction with sets of content filter data provided by content providers 330. For example, the user may indicate that he or she does not follow a particular television series and therefore does not care whether potential spoiler content regarding such television series is displayed. In this example, the user's preferences set forth in the content filter data may override content filter data provided by content providers 330 or may be used separately such as in the case when the content provider does not provide content filter data. In this example, the potential spoiler content is displayed to this user based on the user's preferences indicated in the user supplied content filter data. While the user may not be interested in the television series, the user may be interested and wish to avoid seeing spoiler content from other television series, other types of content, such as games or live sporting events. Spoiler setup performed by a user to indicate the user's preferences and build a personalized set of content filter data is shown in FIG. 4.

In one embodiment, once a user text entry has been identified as including spoiler content and the spoiler tag has been included in the user text entry, such as a post, the collaborative environment periodically re-evaluates the spoiler content to ascertain whether the spoiler content still contains spoiler content. During re-evaluation, the collaborative environment compares the spoiler content to a set of event data. Event data can be any data that can change the status of a posted text from containing spoiler content to not containing spoiler content. Event data might include an updated set of content provider set of content filter data, an updated set of user configurable set of content filter data, presentation of content, such as a television episode, user progress in an electronic game, a product announcement, and an arrival of a calendar date. For example, if the spoiler content pertained to a live sporting event, the posted text might not be considered spoiler content after the passage of an amount of time, such as a week, month, etc. During re-evaluation, the spoiler tag is retained in response to the comparison identifying that the spoiler content is still spoiler content. However, the spoiler content is displayed without the spoiler tag in response to the comparison identifying the that the spoiler content is no longer spoiler content.

FIG. 4 is a depiction of a flowchart showing the logic used in spoiler alert user setup processing. User setup of user-configurable content filter data commences at 400 whereupon, at step 410, the user selects the first content filter type corresponding to “live” content, such as any live content, content containing scores of live events, content containing statistics of live events, content containing contestants competing, eliminated, etc. in a live event, and the like. At step 415, the process receives restriction parameters to use with the selected filter type, such as the number of days the content is considered spoiler data, the number of episodes, etc. A decision is made as to whether there are more filter types that the user wishes to configure for live content (decision 420). If there are additional filter types that the user wishes to configure, then decision 420 branches to the “yes” branch which loops back to select and set the next filter type and restriction parameters as described above. This looping continues until the user does not wish to configure additional live content filters, at which point decision 420 branches to the “no” branch for further user setup processing.

At step 425, the user selects the first general filter that the user wishes to configure (e.g., any sports show, any reality show, any electronic game, etc.). At step 430, the process receives restriction parameters pertaining to the selected general filter (e.g., number of days, episodes, etc.) for which the selected filter is applied. At step 435, the user selects the first content filter type for the selected general filter from step 425. For example, the general filter may be any reality show and the selected filter type, selected at step 435, may be any content pertaining to any reality show, content containing scores pertaining to any reality show, content containing statistics pertaining to any reality show, content containing contestants competing, eliminated, etc. that pertain to any reality show, and the like. At step 440, the process receives restriction parameters to use with the selected filter type for the general filter, such as the number of days the content pertaining to scores in a reality show is considered spoiler data, the number of episodes of reality show data to consider restricted (e.g., the current episode and x previous episodes, etc.), as well as other restriction parameters. A decision is made as to whether there are more filter types that the user wishes to configure for the selected general filter (decision 445). If there are additional filter types that the user wishes to configure, then decision 445 branches to the “yes” branch which loops back to select and set the filter type and receive restriction parameters pertaining to the next selected filter type. This looping continues until the user does not wish to set any additional filter types for the selected general filter, at which point processing branches to the “no” branch. A decision is made as to whether the user wishes to configure additional general filters (decision 450). If the user wishes to configure additional general filters, then decision 450 branches to the “yes” branch which loops back to select the next general filter, the filter types for the next general filter, and the corresponding restriction parameters as described above. This looping continues until the user does not wish to configure additional general filters, at which point decision 450 branches to the “no” branch for user setup processing of specific filters.

At step 455, the user selects the first specific filter, such as a specific game, event, television program, live broadcast, and the like. For example, the user may select a specific television series, a specific sporting event, a specific electronic game, etc. At step 465, the user selects the first content filter type for the selected specific filter that was selected at step 455. For example, the specific filter may be a particular sporting event and the selected filter type, selected at step 465, may be any content pertaining to any aspect of the sporting event, content containing scores pertaining to the sporting event, content containing statistics pertaining the sporting event, content containing contestants competing, eliminated, etc. in the sporting event, and the like. At step 470, the process receives restriction parameters to use with the selected filter type for the specific filter, such as the number of days the content pertaining to scores in the sporting event are considered spoiler data, as well as other restriction parameters. A decision is made as to whether there are more filter types that the user wishes to configure for the selected specific filter (decision 475). If there are additional filter types that the user wishes to configure, then decision 475 branches to the “yes” branch which loops back to select and set the filter type and receive restriction parameters pertaining to the next selected filter type. This looping continues until the user does not wish to set any additional filter types for the selected specific filter, at which point decision 475 branches to the “no” branch. A decision is made as to whether the user wishes to configure additional specific filters, such as additional games, television series, etc. (decision 480). If the user wishes to configure additional specific filters, then decision 480 branches to the “yes” branch which loops back to select the next specific filter, the filter types for the next specific filter, and the corresponding restriction parameters as described above. This looping continues until the user does not wish to configure additional specific filters, at which point decision 480 branches to the “no” branch.

At step 485, the process saves the user configured content filter data in data store 490. User setup of spoiler alert data to use as content filter data thereafter ends at 495.

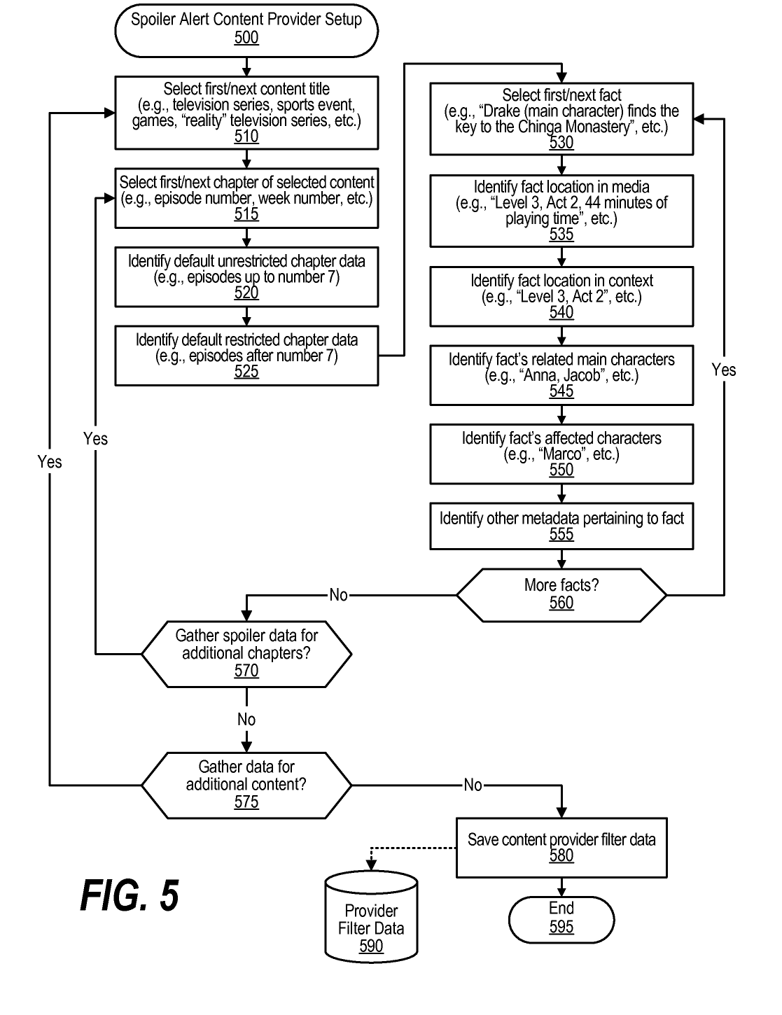

FIG. 5 is a depiction of a flowchart showing the logic used in spoiler alert setup by the content provider. This process, performed by a content provider or perhaps by a user that manages forums or other areas within the collaborative environment where content is discussed, commences at 500 whereupon, at step 510, the provider selects the first content title, such as an television series title, a sports event title, a game title, etc. At step 515, the provider selects the first chapter of the selected content which can be an episode number, a week number, a first release date, etc. At step 520, the provider identifies default unrestricted chapter data, such as a date after which comments and posts concerning the selected chapter will no longer be considered spoiler data. For example, the provider may set the default to be two weeks after the first-aired date. So, using this example, two weeks after the chapter has aired, the default setting would be that comments and posts regarding the selected chapter would no longer be considered spoiler content. Likewise, at step 525, the provider identifies default restricted chapter data, such as a date before which comments and posts concerning the selected chapter are considered to be spoiler comments. Using the example from above, the provider set the default to be two weeks after the first-aired date. So, using this example, for a period of two weeks after the original aired date, the default setting would be that comments and posts regarding the selected chapter would be considered spoiler content. The provider can also set whether comments and posts that occur regarding the episode before the original aired date should be considered spoiler content. For example, speculation about the starters in a sports event may be considered spoiler information even before the sports event is aired.

At steps 530 through 560 facts pertaining to the selected chapter are gathered by the producer to assist the spoiler identification process in its semantic analysis of posts in order to better match posts with content. At step 530, the first fact pertaining to the selected chapter is selected or identified by the provider, such as an action performed by a main character. At step 535, the provider identifies the selected fact's location in the content (media), such as which act the fact occurs, at which time position in the chapter, etc. At step 540, the selected fact's location is identified within the context of the content, such as a level, act, etc. At step 545, related characters to the selected fact are identified. At step 550, affected characters pertaining to the selected fact are identified and, at step 555, any additional metadata pertaining to the selected fact are identified by the provider. A decision is made as to whether there are more facts to describe for the selected chapter (decision 560). If there are more facts to describe, decision 560 branches to the “yes” branch which loops back to select the next fact in the chapter and gather data pertaining to the selected fact as described above. This looping continues until there are no more facts that the provider wishes to describe pertaining to the selected chapter, at which point decision 560 branches to the “no” branch. The gathering of fact data as described above could additionally use other content-related materials, such as scripts, etc. which could be analyzed to gather the facts pertaining to chapters, character involvement, fact location, etc.

A decision is made as to whether there are additional chapters in the content for which the provider is providing spoiler data (decision 570). If there are additional chapters to process, then decision 570 branches to the “yes” branch which loops back to select the next chapter of the selected content, gather the restricted and unrestricted chapter data, and process the facts as described above. This looping continues until there are no more chapters that the provider wishes to describe pertaining to the selected content, at which point decision 570 branches to the “no” branch. A decision is made as to whether there are additional content offerings (e.g., television series, games, etc.) for which the provider is providing spoiler data (decision 575). If there are content offerings to process, then decision 575 branches to the “yes” branch which loops back to select the next content being described by the provider, and gather the chapter data, restriction data, and fact data as described above. This looping continues until there are no more content offerings that the provider wishes to describe, at which point decision 575 branches to the “no” branch.

At step 580, the data gathered by the provider about the content is saved as content filter data in data store 590. Processing of the spoiler alert setup performed by the content provider thereafter ends at 595.

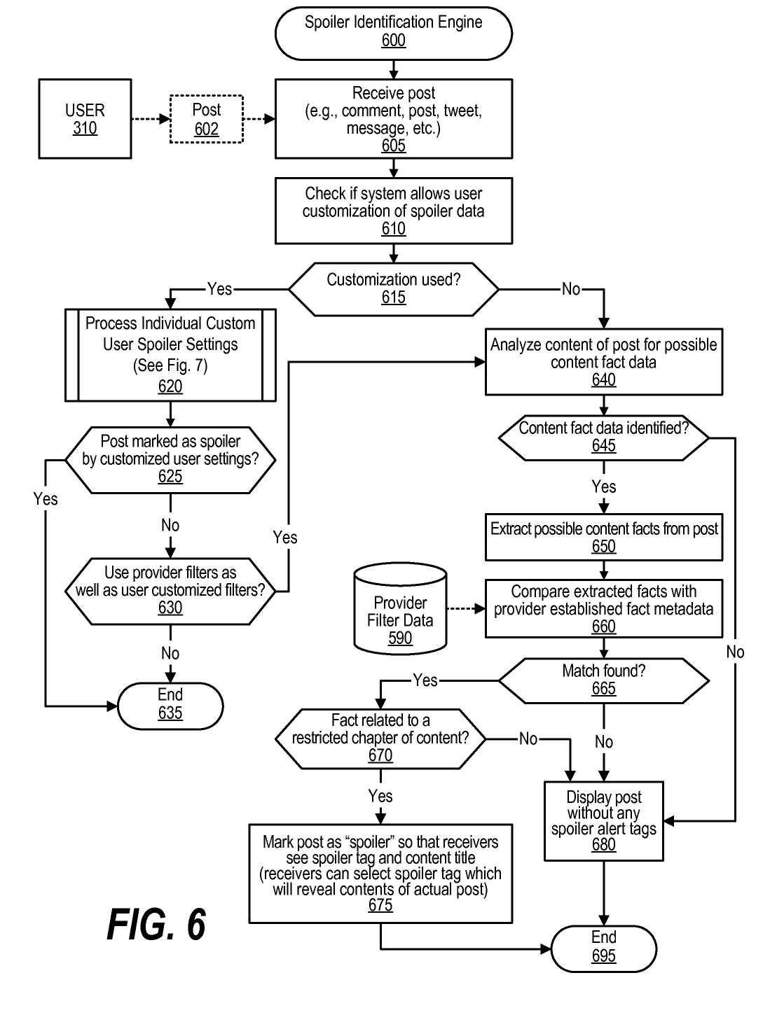

FIG. 6 is a depiction of a flowchart showing the logic used by a spoiler identification engine. Processing of the spoiler identification engine commences at 600 whereupon, the spoiler engine, perhaps running at the collaborative environment's website, receives user text entry 602 from one of the collaborative environment's users (user 310) at step 605. User text entry is any sort of entry handled by the collaborative environment, such as a comment, post, tweet, message, etc. At step 610, the spoiler identification engine checks whether the engine utilizes user configured content filter data. A decision is made as to whether the spoiler identification engine utilizes customized user configured content filter data (decision 615). If user configured content filter data is being used by the spoiler identification engine, then decision 615 branches to the “yes” branch to process any user configured content filter data.

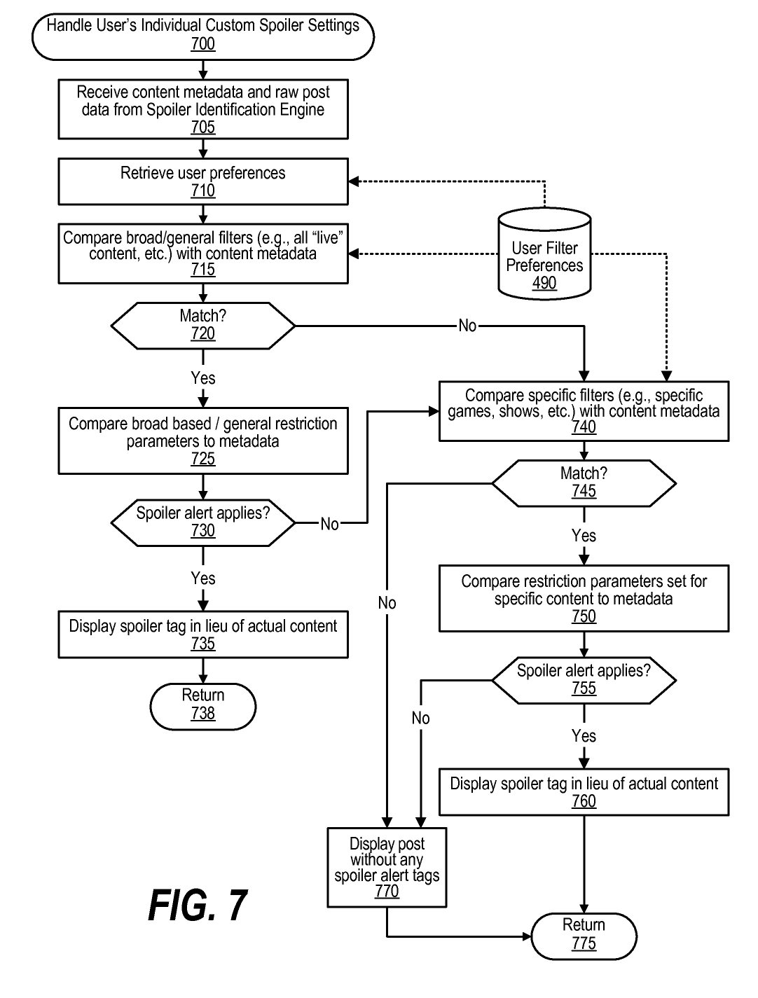

At predefined process 620, the spoiler identification engine processes individual custom user spoiler settings (see FIG. 7 and corresponding text for processing details). Based on the execution of predefined process 620, a decision is made as to whether the user text entry that was received by the spoiler identification engine has been marked as spoiler content by predefined process 620 (decision 625). If the user text entry has already been marked as spoiler content, then decision 625 branches to the “yes” branch and spoiler identification engine processing of the user text entry ends at 635. On the other hand, if the user text entry was not marked as spoiler content by predefined process 620, then decision 625 branches to the “no” branch whereupon a decision is made as to whether the user wishes to utilize additional content filters (e.g., content-provider based content filter data, etc.) at decision 630. If the user has chosen to use additional content filter data if the user's configured content filter data did not mark the user text entry as containing spoiler content, then decision 630 branches to the “yes” branch to continue the filtering process by the spoiler identification engine. On the other hand, if the user only wishes to use the user's configured content filter data, then decision 630 branches to the “no” branch and processing ends at 635 (with the user text entry not being identified as including spoiler content).

If user configured content filter data is not being utilized by the spoiler identification engine (with decision 615 branching to the “no” branch) or if the user configured content filter data did not identify the user text entry as including spoiler content but the user wishes to utilize other available content filter data, such as content-provider content filter data, etc. (with decision 630 branching to the “yes” branch), then step 640 is executed by the spoiler identification engine to analyze the content of the received user text entry in order to identify any possible content fact data (data about content facts, etc.). A decision is made as to whether content fact data was identified (decision 640). If no content fact data was identified, then the user text entry does not include any spoiler content and decision 645 branches to the “no” branch whereupon, at step 680 the user text entry is posted to the collaborative environment without any spoiler tags. For example, if a user posts “I really like this show!”, no facts regarding the content are present in the post and, therefore, the user text entry can be posted without a spoiler alert. On the other hand, if content fact data is identified in the received user text entry submitted to the collaborative environment, then decision 645 branches to the “yes” branch for further analysis.

In one embodiment, the spoiler identification engine performs a semantic analysis on the received user text entry. During the semantic analysis, the user text entry is parsed at step 650 and natural language processing is used to extract context-independent aspects of the user text entry's meaning, including the semantic roles of entities mentioned in the user text entry, such as character names found in television episodes, games, sporting events, etc., as well as quantification information, such as cardinality, iteration, and dependency information included in the user text entry. At step 660, the extracted context-independent aspects of the received user text entry's meaning is compared to the content-provider's content filter data from data store 590 (see FIG. 5 and corresponding text for details regarding the generation of data store 590). A decision is made as to whether a match is identified between the extracted context-independent aspects of the received user text entry's meaning when compared to the content-provider's content filter data (decision 665). If a match is not found, the facts in the post do not match restricted facts in the content chapters and, therefore, the user text entry is deemed to not include spoiler content. In this case, decision 665 branches to the “no” branch whereupon, at step 680 the user text entry is posted to the collaborative environment without any spoiler tags.

On the other hand, if a match is identified between the extracted context-independent aspects of the received user text entry's meaning and the content-provider's content filter data, then decision 665 branches to the “yes” branch for further analysis. A decision is made as to whether the facts in the user text entry relate to a restricted chapter of content (decision 670). If the facts in the user text entry do not relate to a restricted chapter of content, perhaps they relate to an older episode, etc., then decision 670 branches to the “no” branch whereupon, at step 680 the user text entry is posted to the collaborative environment without any spoiler tags. On the other hand, if the facts in the user text entry relate to a restricted chapter of content, such as a recent episode, etc., then decision 670 branches to the “yes” branch whereupon, at step 675, the received user text entry is marked as “spoiler content” so that receivers see a spoiler tag and content title without revealing the spoiler contents included in the user text entry. Users of the collaborative environment can choose to view the spoiler content by selecting the spoiler tag that is included in the post by the spoiler identification engine. After the user text entry has been processed and either displayed without a spoiler alert tag or after inclusion of a spoiler alert tag, processing by the spoiler identification engine ends at 695. Note that when user configured content filter data are being used in the collaborative environment, the spoiler identification engine processing shown in FIG. 6 would be performed for each of the recipients (users of the collaborative environment) since each of the collaborative environment users can have different user configured content filter data. Also, in one embodiment, the spoiler identification engine periodically re-evaluates spoiler content using the steps described above to ascertain whether the post is still considered spoiler content. For example, if the user text entry was a post about a television episode that just aired, then the post might be identified as containing spoiler content and have a spoiler tag included. However, after some period of time, such as a month, the collaborative environment users have had ample opportunity to view the episode and, therefore, the re-evaluation of the post by the spoiler identification engine would determine that the post no longer includes spoiler content (as the content is now older), so the spoiler tag could be removed and the original user text entry would appear in the collaborative environment.

FIG. 7 is a depiction of a flowchart showing the logic performed to handle a user's individual custom spoiler settings. Processing of the routine, which is performed by the spoiler identification engine in one embodiment, commences at 700 whereupon, at step 705 the content metadata and raw user text entry are received from the calling routine in the spoiler identification engine. At step 710, user preferences set by the user when establishing the user configured content filter data are retrieved. At step 715, the broad based content filter data filters, such as those that apply to all content or a wide assortment of content, are applied to the user text entry using the spoiler identification engine's semantic analysis routine. During the semantic analysis, the user text entry is parsed and natural language processing is used to extract context-independent aspects of the user text entry's meaning, including the semantic roles of entities mentioned in the user text entry, such as character names found in television episodes, games, sporting events, etc., as well as quantification information, such as cardinality, iteration, and dependency information included in the user text entry. At step 715, the extracted context-independent aspects of the received user text entry's meaning is compared to the broad-based user configured content filter data from data store 490 (see FIG. 4 and corresponding text for details regarding the generation of data store 490).

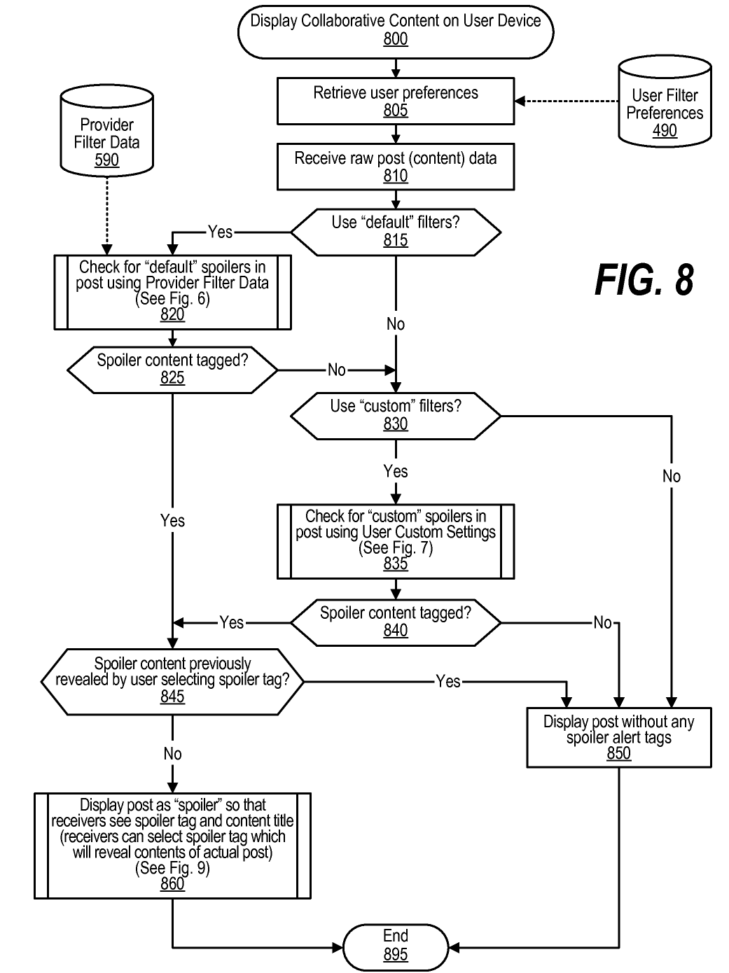

A decision is made as to whether the extracted context-independent aspects of the received user text entry's meaning match the broad-based user configured content filter data (decision 720). If a match is found, then decision 720 branches to the “yes” branch whereupon, at step 725, the broad-based user configured content filter data restrictions are compared to the potential spoiler content included in the user text entry. A decision is made as to whether the facts in the user text entry relate to a restriction set by a broad based filter (decision 730). If the facts in the user text entry do not relate to a restricted broad-based filter, then decision 730 branches to the “no” branch for further analysis to determine whether a user configured specific content filter data applies. On the other hand, if the facts in the user text entry relate to a restricted broad-based filter, then decision 730 branches to the “yes” branch whereupon, at step 735, the received user text entry is marked as “spoiler content” so that the user will see a spoiler tag and content title without seeing the spoiler contents included in the user text entry. The user can choose to view the spoiler content by selecting the spoiler tag that is included in the post by the spoiler identification engine. Processing thereafter returns to the calling routine (see FIGS. 6 and 8) at 738.

If the contents of the user text entry did not match any broad based user configured content filter data (decision 720 branching to the “no” branch) or if it was determined that the user configured broad based filters did not apply to the user text entry (decision 730 branching to the “no” branch), then analysis of user configured specific content filter data is performed starting at step 740 where the user configured specific content filter data is compared with the contents of the user text entry using the semantic analysis as discussed in relation to the broad based filters but here the semantic analysis is performed using the specific user configured content filter data. A decision is made as to whether the facts in the user text entry relate to a restriction set by a specific based content filter (decision 745). If the facts in the user text entry do not relate to a specific user configured content filter, then decision 745 branches to the “no” branch whereupon, at step 770 the user text entry is posted to the user's collaborative environment area without any spoiler tags. Of course, another user of the collaborative environment might have configured different settings where the same user text entry (post) is protected with a spoiler tag.

On the other hand, if the facts in the user text entry relates to a restricted specific-based user configured filter, then decision 745 branches to the “yes” branch whereupon, at step 750, the specific-based user configured content filter data restrictions are compared to the potential spoiler content included in the user text entry. A decision is made as to whether the facts in the user text entry relate to a restriction set by a broad based filter (decision 755). If the facts in the user text entry are not restricted based on a specific-based filter, then decision 755 branches to the “no” branch, whereupon at step 770 the user text entry is posted to the user's collaborative environment area without any spoiler tags. Once again, another user of the collaborative environment might have configured different settings where the same user text entry (post) is protected with a spoiler tag.

On the other hand, if the facts in the user text entry relate to a restricted specific-based filter that applies to the user text entry, then decision 755 branches to the “yes” branch whereupon, at step 760, the received user text entry is marked as “spoiler content” so that the user will see a spoiler tag and content title without seeing the spoiler contents included in the user text entry. The user can choose to view the spoiler content by selecting the spoiler tag that is included in the post by the spoiler identification engine. Processing thereafter returns to the calling routine (see FIGS. 6 and 8) at 775.

Also, in one embodiment, similar to the spoiler processing shown in FIG. 6, in FIG. 7, the spoiler identification engine periodically re-evaluates spoiler content using the steps described above to ascertain whether the post is still considered spoiler content. For example, if the user text entry was a post about a television episode that just aired, then the post might be identified as containing spoiler content and have a spoiler tag included. However, after some period of time, such as a month, the user's configured content filter data might indicate that the spoiler content is no longer spoiler content. Therefore, the re-evaluation of the post by the spoiler identification engine would determine that the post no longer includes spoiler content (as the content is now older), so the spoiler tag could be removed and the original user text entry would appear to the user instead of the spoiler tag.

FIG. 8 is a depiction of a flowchart showing the logic used to display collaborative content on a user's display device. Processing commences at 800 whereupon, at step 805, the user's preferences are retrieved from data store 490. At step 810, the user's device, such as a mobile device or other computing device, receives the raw user text data, such as at a browser application. A decision is made as to whether the user has requested to use default filters, such as those established by content providers (decision 815). If default filters are being used at the device, then decision 815 branches to the “yes” branch whereupon, at predefined process 820, default filters, such as those established by content providers, are retrieved from data store 590 and used to check the received user text entry for spoiler content (see FIG. 6 and corresponding text for processing details). A decision is made as to whether spoiler content was found by predefined process 820 (decision 825).

If either spoiler content was not identified by the default filters (with decision 825 branching to the “no” branch) or if the user has elected to not use default filters (with decision 815 branching to the “no” branch), then a decision is made as to whether the user has configured custom user-configured content filters to check the incoming user text entry (decision 830). If custom (user configured) content filters are not being used, then decision 830 branches to the “no” branch whereupon, at step 850, the user text entry is displayed on the user's device without any spoiler tags. On the other hand, if custom (user configured) content filters are being used, then decision 830 branches to the “yes” branch whereupon, at predefined process 835, the received user text entry is checked for user configured spoilers based on the user configured content filter data (see FIG. 7 and corresponding text for processing details). A decision is made as to whether predefined process 835 identified spoiler content in the received user text entry (decision 840). If predefined process 835 did not identify any spoiler content in the received user text entry, then decision 830 branches to the “no” branch whereupon, at step 850, the user text entry is displayed on the user's device without any spoiler tags. On the other hand, if predefined process 835 identified spoiler content in the received user text entry, then decision 840 branches to the “yes” branch for further processing.

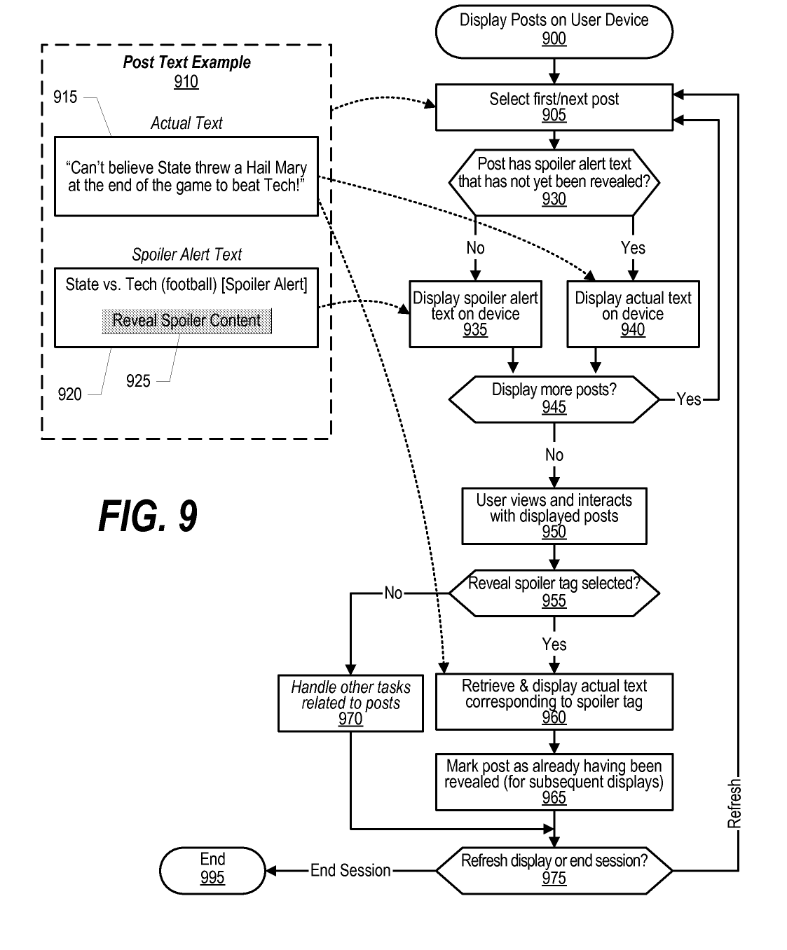

If spoiler content was identified using either default content filters (with decision 825 branching to the “yes” branch) or using user configured content filters (with decision 840 branching to the “yes” branch), then a decision is made as to whether the post has already (previously) been revealed by the user of the device selecting the spoiler tag associated with the post (decision 845). If the user has already (previously) revealed the spoiler content by previously selecting the spoiler tag, then decision 845 branches to the “yes” branch whereupon, at step 850, the user text entry is displayed on the user's device without any spoiler tags. On the other hand, if the user has not previously selected the spoiler tag for this post, then decision 845 branches to the “no” branch whereupon, at predefined process 860, the user text entry is modified to hide the spoiler content so that the user does not see the spoiler content and a spoiler tag is inserted that the user can select to view the spoiler content (see FIG. 9 and corresponding text for processing details). After the user text entry has been displayed, processing ends at 895.

FIG. 9 is a depiction of a flowchart showing the logic used to display posts on the user's display device. Processing commences at 900 whereupon, at step 905, the first post (e.g., in a forum, topic, etc.) is selected. Post text examples are shown in 910. Post example 915 shows an example of a user text entry that was submitted by a user of the collaborative environment. The text includes spoiler content that reveals the outcome of a sporting event. Therefore, the post that is shown to the user is post example 920 that includes spoiler tag 925, such as a command button, hyperlink, or the like, that is selectable by the receiving user to reveal the spoiler content. So, in the example shown, if the user selects spoiler tag 925, the actual text as shown in example post 915 would be shown revealing the spoiler content.

A decision is made as to whether the selected post includes spoiler content that has not yet been revealed by the user (decision 930). If either the selected post does not include spoiler content or the user has previously revealed the spoiler content by selecting the spoiler tag, then decision 930 branches to the “yes” branch whereupon, at step 940, the actual user text entry is displayed on the device. On the other hand, if the selected post includes spoiler content that has not yet been revealed by the user of the device, then decision 930 branches to the “no” branch whereupon, at step 935 the post is displayed with the spoiler tag that protects the user from viewing unwanted spoiler content. A decision is made as to whether there are more posts to process (decision 945). If there are more posts to process, then decision 945 branches to the “yes” branch which loops back to select and display the next post as described above. This looping continues until all of the posts have been processed, at which point decision 945 branches to the “no” branch whereupon, at step 950, the user interacts with the displayed posts.

A decision is made as to whether the user has selected a spoiler tag associated with one of the displayed posts (decision 955). If the user has selected a spoiler tag associated with one of the displayed posts, then decision 955 branches to the “yes” branch whereupon, at step 960, the actual text of the post is retrieved and displayed on the user's display device. At step 965, the post is marked to indicate that the user has already viewed the spoiler content so that subsequent views of the posts on the device will reveal the actual text of this post rather than the spoiler tag. Returning to decision 955, if the user has not requested a spoiler tag, then decision 955 branches to the “no” branch whereupon the user's request is processed at 970.

A decision is made as to whether to refresh the display or end the session (decision 975). If the user has not requested to end the session (e.g., by closing the application, browser, etc.), then decision 975 branches to the “refresh” branch which loops back to select and display the posts as described above. This refresh processing continues until the user ends the session, at which point decision 975 branches to the “end session” branch and processing ends at 995.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of detecting and hiding spoiler information, the method, implemented by an information handling system, comprising:
automatically detecting, by a processor, potential spoiler content in a user text entry submitted to a collaborative environment; and
inhibiting display of the potential spoiler content from the collaborative environment in response to the detection.

2. The method of claim 1 wherein the inhibiting is performed until an evaluation of the potential spoiler content is performed, and wherein the method further comprises:
evaluating the potential spoiler content, wherein the evaluating further comprises:
comparing the potential spoiler content to one or more sets of content filter data;
inserting a spoiler tag in response to the comparison identifying that the potential spoiler content is spoiler content, wherein the spoiler tag is selectable by users of the collaborative environment to reveal the spoiler content; and
displaying the potential spoiler content in response to the comparison identifying the that the potential spoiler content is non-spoiler content.

3. The method of claim 2 wherein the automatic detecting and comparing steps are performed according to a semantic analysis.

4. The method of claim 2 further comprising:
receiving a spoiler tag selection from a selected one of the users of the collaborative environment, wherein the spoiler tag selection corresponds to the spoiler content; and
displaying the spoiler content to the selected user in response to receiving the spoiler tag selection.

5. The method of claim 2 further comprising:
after insertion of the spoiler tag:
periodically re-evaluating the spoiler content, wherein the re-evaluation further comprises:
comparing the spoiler content to a set of event data;
retaining the spoiler tag in response to the comparison identifying that the spoiler content is still spoiler content; and
displaying the spoiler content without the spoiler tag in response to the comparison identifying the that the spoiler content is no longer spoiler content.

6. The method of claim 5 wherein the set of event data are selected from the group consisting of an updated set of content provider set of content filter data, an updated set of user configurable set of content filter data, a presentation of an episode, a user progress in an electronic game, a product announcement, and an arrival of a calendar date.

7. The method of claim 1 further comprising:
comparing the user text entry with one or more sets of content filter data, wherein the sets of content filter data are selected from the group consisting of a content provider set of content filter data and a user configurable set of content filter data.
